(19) United States
(12) Patent Application Publication
(10) Pub. No.: US 2006/0076299 A1
(43) Pub. Date: Apr. 13, 2006

(54) Synthesis of bentonite clay-based iron nanocomposite and its use as a heterogeneous photo fenton catalyst

(75) Inventors: Jiyun Feng, Metro City Phase 1 (HK); Po Lock Yue, Kowloon (HK); Xijun Hu, Clear Water Bay (HK); Shiu Kai Raymond Wong, Mid-levels (HK)

Correspondence Address: COOPER & DUNHAM, LLP, 1185 AVENUE OF THE AMERICAS, NEW YORK, NY, 10036, US

(73) Assignee: The Hong Kong University of Science and Technology

(21) Appl. No.: 10/961,306

(22) Filed: Oct. 8, 2004

(51) Int. Cl. C02F 1/72

(52) U.S. Cl. 210/748; 210/759; 210/209

(57) ABSTRACT

The present invention provides a method of synthesizing bentonite clay-based Fe nanocomposite, that may be used as a heterogeneous photo Fenton catalyst in advanced oxidation processes (AOP's) for wastewater treatment.

### FIELD OF THE INVENTION

This invention relates to synthesis of a bentonite clay based Fe nanocomposite and its application as a heterogeneous photo Fenton catalyst in Advanced Oxidation Processes (AOP's) for wastewater treatment.

### BACKGROUND OF THE INVENTION

Wastewaters generated in chemical and textile industry contain significant amounts of organic pollutants, such as azo dyes. They contribute significantly to water pollution, and most of them are stringently controlled by legislation. Azo dyes are very toxic to plants, animals, and human beings, and therefore must be treated before being discharged.

During the past ten years, various advanced oxidation processes (AOP's) have been developed for the treatment of the wastewater containing organic pollutants. In principle, AOP's are based on the generation of OH radicals in water, which are highly oxidative, nonselective, able to oxidize organic compounds, particularly unsaturated organic compounds such as azo dyes. Among AOP's, one of the most important processes to generate OH radicals is using the Fe²⁺/H₂O₂/UV system, where the catalyst ferrous ions are dissolved in water. Called homogeneous photo-Fenton system, the Fe²⁺ ions in solution function as a homogeneous catalyst. The formation of OH radicals and regeneration of Fe²⁺ by photo reduction from Fe³⁺ can be expressed by the following equations:
Fe²⁺+H₂O₂+UV→Fe³⁺+•OH+OH— (1)
Fe(OH)²⁺+UV→Fe²⁺+•OH (2)

The homogeneous photo-Fenton process, however, has at least one significant disadvantage. The removal of the sludge containing Fe ions at the end of wastewater treatment is rather costly, and requires large amounts of chemicals and manpower. This drawback limits the use of homogeneous photo-Fenton reaction in industry wastewater treatment. To overcome the disadvantage of homogeneous photo-Fenton process, some attempts have been made to develop a heterogeneous photo-Fenton or photo-Fenton-like process by coating Fe ions, Fe oxide or Cu onto porous solid support as the catalyst. This heterogeneous catalyst does not dissolve in water. To prepare a heterogeneous catalyst for photo-Fenton process, various supports have been used including organic and inorganic materials.

For example, Nafion film has been used as an organic support in this process. It contains sulfonic groups that can effectively anchor Fe ions, on which Na ions can be replaced by Fe³⁺ ions through a simple ion exchange reaction. For example, J. Fernandez et al. prepared the catalyst with Nafion perfluorinated cation transfer membrane (Dupont 117, 0.007 in, Aldrich #7 467-4) containing hydrophilic sulfonate groups immobilized on the fluorocarbon matrix. The ion exchange with FeCl₃.6H₂O was carried out for a few minutes after the Nafion membrane was immersed in HCl solution. After the ion exchange, the membrane was washed with water followed by immersion in 1 M NaOH to convert Fe³⁺ to its hydrated form.

They used the catalyst for the abatement of non-biodegradable azo-dye in the presence of UV light and H₂O₂. However, the Nafion film based catalyst has many disadvantages, even though the catalyst can be separated easily from solution. First, the Nafion film catalyst showed low photo catalytic activity due to its low specific surface area. Second, the catalyst is too expensive to be used as a heterogeneous photo Fenton catalyst in industrial wastewater treatment. The price of Nafion film is quite high.

In addition to Nafion film, Nafion pellets containing sulfonic groups were also employed as an organic support for the preparation of heterogeneous photo Fenton catalyst. Puma and Yue prepared Fe-Nafion pellets through ion exchange method, and used them as a heterogeneous photo Fenton catalyst in the oxidation of Indigo Carmine dye. Their preliminary result indicates that the Fe-Nafion pellets are effective in reducing the concentration of the dyes in solution. However, the Fe-Nafion pellet catalyst also shows low photo catalytic activity and high cost.

Apart from Nafion film and Nafion pellets, another support used for the preparation of heterogeneous photo Fenton catalyst is zeolite Y. Bossmann et al. prepared Fe (III) doped zeolite Y as the heterogeneous photo Fenton catalyst in the oxidation of PVA. They found that contrary to the homogeneous reaction mechanism, the degradation of PVA using the system zeolite Y/Fe(III)/H₂O₂ generates low molecular weight reaction products because DOC-removal remains at a high level after reacting 120 minutes. In addition, they confirmed that Fe(III) does not form complexes with PVA and its oxidation products. Most likely, the Fe(III) remains bound inside the zeolite Y framework. Their results reveal that the catalyst has a poor photo catalytic activity.

Further, Hu et al. prepared copper/MCM-41 as catalyst for photochemically enhanced oxidation of phenol by hydrogen peroxide. Because MCM41 is an expensive support, the catalyst also has disadvantages similar to Nafion based catalyst. Apart from this, the catalyst exhibited a low photo catalytic activity in the oxidation of phenol in the presence of UV light and H₂O₂. In other words, similar to Nafion based catalyst mentioned above, introducing a cheap catalyst on an expensive support is not a good choice.

U.S. Pat. No. 5,755,977 (Gurol) discusses a continuous catalytic oxidation process. In this process, particulate mineral oxide selected from iron oxide, manganese oxide, mixtures of iron oxide and manganese oxide, and mixtures containing these mineral oxides were used as catalysts. The process does not appear to involve UVC light.

U.S. Pat. No. 6,663,781 (Huling) relates to contaminant adsorption and oxidation via the Fenton reaction. In the process, iron was attached to granulated activated carbon. The obtained iron.GAC was used as an adsorbent and a catalyst via the Fenton reaction for contaminant adsorption and oxidation.

Based on the discussions above, there is a need for a high efficiency, low cost heterogeneous catalyst for photo-Fenton reaction. Layered clays such as laponite and bentonite have been used as catalyst supports due to their unique properties and structures, their abundance, and relatively low cost. For example, Wang et al. developed clay-based nickel catalysts for methane reforming. Zhu et al. pointed out that some kinds of layered clay such as laponite has very small platelets, 20-30 nm in diameter, while Fe₂O₃ can be intercalated as pillars. The pillaring technique has been described by Burch, R. Ed. Pillared Clays, Catalysis Today, Elsevier: New York, 1998, and Mitchell, I V., Ed. Pillared Layered Structures, Current Trends and Applications, Elsevier Applied Science, London, 1990. In addition, both Feng et al. and He et al. showed that nano-sized Fe₂O₃ exhibited photo catalytic activity as a heterogeneous photo Fenton catalyst in the presence of H₂O₂ and UV light.

U.S. Pat. No. 5,202,295 (McCauley) discloses the intercalated clay having large interlayer spacing.

U.S. Pat. No. 4,980,047 (McCauley) describes stable intercalated clays and preparation method. However, their intercalated clays are mainly used as oil cracking catalysts.

The biggest advantages of the bentonite clay based Fe nanocomposite as a heterogeneous photo Fenton catalyst for wastewater treatment can be summarized as follows: (1) high photo catalytic activity; (2) long-term stability; and (3) low cost.

### OBJECTS OF THE INVENTION

It is, therefore, the primary object of this invention to develop a bentonite clay based Fe nanocomposite using so-called pillaring technique.

It is a further object of this invention to employ this Fe nanocomposite as a heterogeneous photo Fenton catalyst in Advanced Oxidation Processes for wastewater treatment at optimal solution pH.

It is a further object of this invention to employ this Fe nanocomposite as a heterogeneous photo Fenton catalyst in Advanced Oxidation Processes for wastewater treatment at initial solution pHs.

### SUMMARY OF THE INVENTION

The invention provides a method for synthesizing a bentonite clay-based Fe nanocomposite (Fe—B), using a pillaring technique, comprising the steps of: (a) forming an aqueous bentonite suspension; (b) forming an Fe³⁺ pillaring solution by adding powder NaCO₃ to an Fe(NO₃)₃ aqueous solution; (c) adding the Fe³⁺ pillaring solution obtained in step (b) to the aqueous bentonite suspension obtained in step (a) with vigorous stirring to form bentonite Fe³⁺ pillaring solution mixture; (d) aging the mixture at room temperature or 100° C. for 48 hours; (e) separating by centrifugation and washing the mixture to obtain a catalyst precursor precipitate; and (f) calcining the catalyst precursor to form intercalated bentonite iron oxide catalyst nanoparticles.

The invention also provides a reactor for treatment of wastewater, comprising: a stainless steel vessel having Fe—B nanoparticles in accordance with claim 1 sprayed to form a layer thereof on an inner wall surface; a UV light source to irradiate wastewater in the reactor; a hydrogen peroxide source for adding hydrogen peroxide to wastewater in the reactor; means for introducing wastewater in the reactor for treatment; and means for removing wastewater from the reactor after treatment.

### BRIEF DESCRIPTION OF THE DRAWINGS

Other objects, advantages and features of the present invention will become apparent upon consideration of the following detailed disclosure, taken in conjunction with the drawings, in which some embodiments of present invention will now be described by way of example and with reference to accompanying drawings, in which:

FIG. 1 is a schematic diagram illustrating the synthesis of a bentonite clay based nanocomposite by the pillaring technique;

FIG. 2 is an x-ray diffraction pattern of a Fe—B nanocomposite;

FIG. 3 is a schematic diagram of a batch photo reactor wherein the Fe—B nanocomposite of the present invention is used as a dispersed heterogeneous photo Fenton catalyst;

FIG. 4 plots discoloration of 0.2 mM Orange II in a batch reactor under different conditions;

FIG. 5 plots Fe concentration in solution under different conditions;

FIG. 6 plots mineralization of 0.2 mM Orange II in a batch reactor under different conditions;

FIG. 7 plots discoloration of 0.2 mM Orange II in a batch reactor under different initial solution pHs;

FIG. 8 plots mineralization of 0.2 mM Orange II in a batch reactor under different initial solution pHs;

FIG. 9 is a schematic diagram of a batch photo reactor when the Fe—B nanocomposite film is used as a heterogeneous photo Fenton catalyst;

FIG. 10 plots discoloration of 0.2 mM Orange II in a batch reactor under different conditions;

FIG. 11 plots mineralization of 0.2 mM Orange II in a batch reactor under different conditions;

FIG. 12 plots multi-run experiments; and

FIG. 13 is a schematic diagram of a batch falling film photo reactor when the Fe—B nanocomposite film is used as a heterogeneous film photo Fenton catalyst.

### DETAILED DESCRIPTION OF THE INVENTION

The invention provides a method for synthesizing bentonite clay-based Fe nanocomposite (Fe—B), using a pillaring technique, comprising the steps of: (a) forming an aqueous bentonite suspension; (b) forming an Fe³⁺ pillaring solution by adding powder NaCO₃ to an Fe(NO₃)₃ aqueous solution; (c) adding the Fe³⁺ pillaring solution obtained in step (b) to the aqueous bentonite suspension obtained in step (a) with vigorous stirring to form bentonite Fe³⁺ pillaring solution mixture; (d) aging the mixture at room temperature or 100° C. for 48 hours; (e) separating by centrifugation and washing the mixture to obtain a catalyst precursor precipitate; and (f) calcining the catalyst precursor to form intercalated bentonite iron oxide catalyst nanoparticles.

The invention further provides a process for treating wastewater comprising: providing a reactor vessel containing Fe—B nanocomposite dispersed nanoparticles heterogeneous photo Fenton catalyst; introducing untreated wastewater into the reactor vessel; and exposing the wastewater to H₂O₂ in the presence of UV light to oxidize contaminants in the wastewater. Preferably, the process is carried out at a pH of between about 2.8 through 3.2, and the initial solution pH ranges from about 2.8 through 7.0.

The invention also provides a process for treating wastewater in a reactor vessel, wherein the reactor vessel is stainless steel and the Fe—B nanoparticles are spray coated on the surface thereof by a hot spray method to form a layer thereon. Preferably, the stainless steel surface is sand blasted prior to spray coating. The Fe—B nanoparticles are coated on the inner wall surface of a reactor, such as a batch photo reactor, and are used as a photo Fenton catalyst in the presence of UV light and H₂O₂ for wastewater treatment at an initial solution pH of between about 2.8 to 7.0.

In another embodiment, the Fe—B nanocomposite film is coated on the inner wall surface of a cylindrical falling film photo reactor, and is used as a photo Fenton catalyst in the presence of UVC light and H₂O₂ for the wastewater treatment at an initial solution pH of between about 2.8 and about 7.0.

The invention additionally provides a reactor for treatment of wastewater, comprising: a stainless steel vessel having Fe—B nanoparticles sprayed on the inside surface thereof to form a layer thereof on an inner surface; a UV light source to irradiate wastewater in the reactor; a hydrogen peroxide source for adding hydrogen peroxide to wastewater in the reactor; means for introducing wastewater in the reactor for treatment; and means for removing wastewater from the reactor after treatment.

In a further embodiment, the stainless steel vessel is an elongated column with a UV light source disposed therein, and the wastewater can be continuously processed in a reactor loop. Preferably, the UV light source is a UVC light source.

The invention also provides a process for the synthesis of a bentonite clay based Fe nanocomposite (Fe—B), and its use as a heterogeneous photo Fenton catalyst in AOP's for wastewater treatment are provided for the first time.

The synthesis of Fe—B nanocomposite was performed using the so-called pillaring technique. In this synthesis, when bentonite clay was dispersed in water, it swelled significantly because of hydration of the interlamellae cations which act as counterions to balance the negative charges of the bentonite clay layers. Then, the inorganic polycations, the so-called pillar precursors could be intercalated the interlayer gallery by cation exchange. During subsequent calcinations at high temperature, the intercalated Fe ions are converted iron oxide pillars that prop the clay layer apart. Because the interlayer distance is in nano-scale, the size of iron oxide is also in nano-scale. Consequently, the Fe—B nanocomposite is synthesized.

It was discovered that as a heterogeneous photo Fenton catalyst, the Fe—B nanocomposite exhibited a high photo catalytic activity and long-term stability in the discoloration and mineralization of azo dye Orange II in the presence of UVC (254 nm) and H₂O₂. In addition, it has a low cost.

The Fe—B nanocomposite can be used a dispersed heterogeneous catalyst in a batch photo reactor for the wastewater treatment or as a film catalyst in a batch or continuous falling film photo reactor for the wastewater treatment.

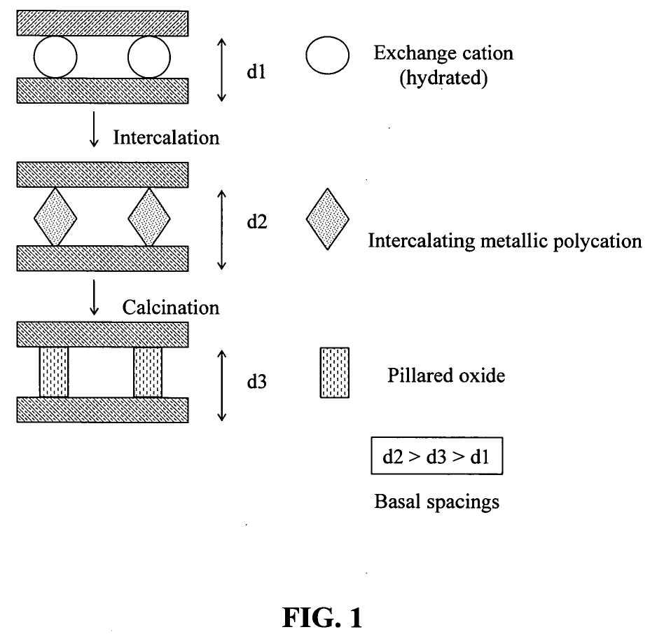

The present invention represents the synthesis of bentonite clay based Fe nanocomposite (Fe—B) for the first time. The theoretical principle for the synthesis of the Fe—B nanocomposite is illustrated in FIG. 1, and includes several steps set forth as follows: (a) bentonite clay swells when dispersed in water; (b) ion exchange between the cations on the clay and Fe³⁺ ions in pillaring solution; and (c) calcination converts Fe³⁺ ions between the layers of bentonite into Fe₂O₃ pillars.

The nano-sized Fe₂O₃ particles or composites containing nano-sized Fe₂O₃ can work as a heterogeneous photo Fenton catalyst in the presence of UV light and H₂O₂. Possible mechanisms for generating •OH radicals are expressed as follows:

Feng et al. proposed a mechanism for a laponite clay based Fe nanocomposite (Fe-Lap-RD) functioning as a heterogeneous photo Fenton catalyst in the discoloration and mineralization of Reactive Red HE-3B in the presence of UVC light and H₂O₂. In this mechanism:
Fe³⁺ on the surface of Fe-Lap-RD+hν→Fe²⁺ on the surface of Fe-Lap-RD (3)
Fe²⁺ on the surface of Fe-Lap-RD+H₂O₂→Fe³⁺ on the surface of Fe-Lap-RD+•OH+OH⁻ (4)
Fe-lap-RD-HE-3B+•OH→Reaction intermediates→CO₂+H₂O (5)

The reactions are initiated by the photo-reduction of Fe³⁺ on the surface of Fe-Lap-RD to Fe²⁺ under irradiation of UV light. Then, the Fe²⁺ formed accelerates the decomposition of H₂O₂ adsorbed on the surface of Fe-Lap-RD, generating highly oxidative OH radicals while the Fe²⁺ is oxidized by H₂O₂ into Fe³⁺. Furthermore, the OH radicals attack HE-3B adsorbed on the surface of the Fe-Lap-RD, giving rise to reaction intermediates such as adjacent ring structures. Finally, the reaction intermediates are mineralized into CO₂, H₂O, and small amount of inorganic acid.

He et al. proposed another mechanism in the heterogeneous photo Fenton degradation of an Azo dye MY 10 as described as below:
≡Fe^{III}OH+H₂O₂→≡Fe^{III}OOH+H₂O
≡Fe^{III}OOH+hν→≡Fe^{IV}=O+•OH
≡Fe^{IV}=O+H₂O→≡Fe^{III}OH+•OH
MY10+•OH→degraded or mineralized products

Using the Fe—B as a dispersed catalyst in water increases efficiency because the catalyst has a large BET surface area. The disadvantage of Fe—B as a dispersed catalyst is that after reaction, a filtration process is needed.

An important improvement for the Fe—B catalyst is to coat the Fe—B catalyst on stainless steel surface as a catalyst film or layer using a Fe—B catalyst film or layer avoids the filtration or separation step. This process can pre-treat wastewaters before they undergo biological treatment.

The following examples are presented to illustrate the present invention, but should not be considered as a limitation of the scope thereof.

### EXAMPLE 1

### Synthesis of Fe—Bentonite Nanocomposite

The Fe—B nanocomposite was prepared through the following steps:
(a) An aqueous dispersion of bentonite clay was prepared by adding 10 g bentonite clay to 500 ml H₂O under vigorous stirring for 3 hours at room temperature. The bentonite clay was obtained from Integrated Mineral Technology Ltd, Australia.
(b) Sodium carbonate Na₂CO₃ was added slowly as a powder into a vigorously stirred 0.2 M solution of iron nitrate for 3 hours such that a molar ratio of 1:1 for [Na⁺]/[Fe³⁺] was established. Na₂CO₃ and Fe₃(NO₃)₃.9H₂O were purchased from Aldrich.
(c) 500 ml solution obtained from the step (b) was then added drop-wise into the dispersion of bentonite clay prepared in the first step, under vigorous stirring.
(d) The suspension was stirred for 3 hours followed by aging at 100° C. in an autoclave for 48 hours. The precipitate was recovered from the mixture by centrifuging, and then washed with deionized water to remove all Na ions. The precipitate was dried in air at 120° C. overnight.

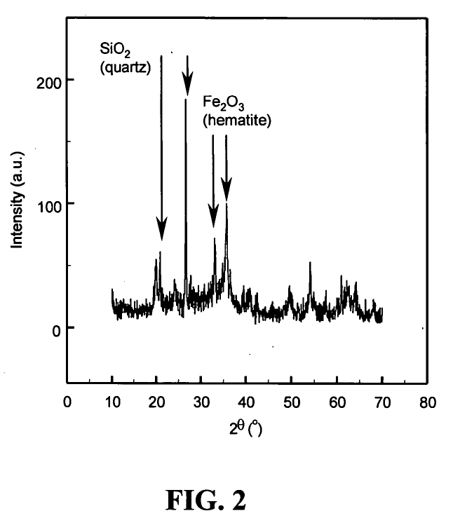

(f) The dried solid was calcined at 350° C. for 24 hours and the Fe—Bentonite nanocomposite Fe—B was obtained. The X-ray diffractive pattern in FIG. 2 indicates that the Fe—B nanocomposite mainly consists of Fe₂O₃ (hematite) and SiO₂ (quartz) crystallites. The BET surface specific area was determined to be 280 m²/g. The Fe concentration with respect to the total weight is 31.8 wt %. The Fe concentration in the Fe—B nanocomposite was also measured by ICP. The Fe concentration is 33.8 wt %, which agrees well with the result obtained by x-ray diffraction. Table 1 shows the bulk chemical compositions of the Fe—B nanocomposite:

TABLE 1
Bulk Chemical Compositions of Fe—B
Nanocomposite Determined by XRF

| Element | concentration (wt %) |
|---|---|
| O | 45.1511 |
| Na | 0.1176 |
| Mg | 0.7271 |
| Al | 4.4895 |
| Si | 17.2437 |
| K | 0.0717 |
| Ca | 0.0252 |
| Ti | 0.0796 |
| Mn | 0.2780 |
| Fe | 31.8165 |

Table 2 lists surface atomic compositions and binding energy of the Fe—B nanocomposite determined by XPS:

TABLE 2
Surface Atomic Compositions and Binding Energy
(BE) of Fe—B Nanocomposite Determined by XPS

| | Atomic | Binding |
|---|---|---|
| Element | concentration (at %) | energy (eV) |
| C1s | 6.05 | 284.8 |
| O1s | 60.23 | 531.6 |
| Mg1s | 1.08 | 1303.9 |
| AI2p | 4.86 | 74.2 |
| Si2p | 15.53 | 102.1 |
| Ca2p3 | 0.01 | 351.8 |
| Fe2p | 12.25 | 711.8 |

### EXAMPLE 2

### Fe—B Nanocomposite As A Heterogeneous Photo Fenton Catalyst In the Discoloration And Mineralization of Azo Dye Orange II At An Optimal Initial Solution PH of 3.0

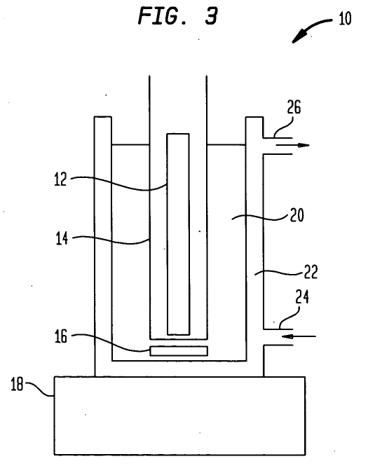

The model pollutant for the evaluation of Fe—B catalyst is an azo-dye, Orange II, a non-biodegradable dye widely used in textile industry. Thus, it is a suitable model pollutant. The Orange II was available from Acros Organics, USA. The photo-Fenton discoloration and minerlization of Orange II was performed in a photo reactor 10, as shown in FIG. 3. It is cylindrical with a UVC lamp 12 (Philips 8 W 254 nm) inserted in a quality table 14 the center.

A stirring bar 16 driven by an electromagnetic stirrer 18 vigorously stirs the reaction solution 20. A water jacket 22 through which water enters 24 and exits 26 cools (or possible warms) the reaction solution 20 as needed. The total volume of Orange II solution was 0.5 liter and the initial Orange II concentration used was fixed at 0.2 mM except otherwise specified. The reaction solution pH was adjusted to 3.0±0.1, which is the optimal value for the (photo) Fenton reaction. The reaction temperature was controlled to be 30° C. by a water bath except otherwise specified. In order to ensure a good dispersion of the Fe—B catalyst in the Orange II solution, an electromagnetic stirrer was used. The starting point of the reaction was treated as the time when the UV light was turned on and 30% by weight H₂O₂ (Aldrich) was added to the Orange II solution.

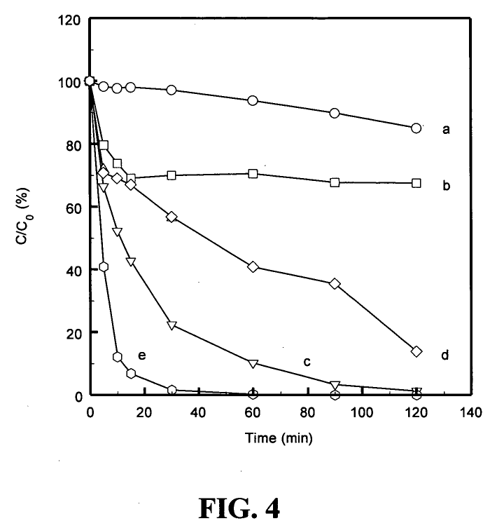

FIG. 4 shows the relative Orange II concentration versus time under different conditions. The Orange II concentration was determined by an UV-VIS spectrometer (Shimadzu UV MINI 1240 UV-VIS spectrophotometer). Without Fe—B catalyst and H₂O₂, with only 1×8 W UVC (curve a), there is little discoloration of Orange II, because the Orange II itself can resist UVC light. Without UVC light (dark) and H₂O₂, with only 1.0 g Fe—B/L (curve b), the decrease in the Orange II concentration is very fast in the first 15 minutes and then reaches a steady state of 30% removal. The fast decrease in the first 15 minutes is due to the adsorption of Orange II on the surface of Fe—B catalyst. The adsorption capacity of Fe—B catalyst is estimated to be around 20 mg Orange II/g Fe—B catalyst. Without Fe—B catalyst, but with 10 mM H₂O₂ and 1×8 W UVC (curve c), the discoloration of Orange II is quite significant, owing to the oxidation of Orange II by OH radicals from the direct photolysis of H₂O₂ in the presence of 1×8 W UVC. Without UVC light (dark), but with 1.0 g Fe—B/L and H₂O₂ (curve d), the discoloration of Orange II is continuous.

Apparently, there are two processes contributing to the discoloration of Orange II observed. One is the adsorption of Orange II on the surface of Fe—B, which causes the discoloration of Orange II in the first 15 minutes. Also, the oxidation of Orange II by OH radicals coming from Fenton reaction causes the discoloration of Orange II after 15 minutes. However, the discoloration of Orange II using a Fenton reaction instead of photo-Fenton reaction is not effective. With 1×8 W UVC, 1.0 g Fe—B/L, and 10 mM H₂O₂ (curve e), the discoloration of Orange II appears to work best. Complete discoloration of Orange II can be achieved in less than 60 minutes. However, we are unsure whether faster discoloration of Orange II is due to the oxidation of Orange II by the OH radicals coming from the heterogeneous photo-Fenton reaction or from homogeneous photo-Fenton reaction owing to the Fe ions leaching from the Fe—B catalyst.

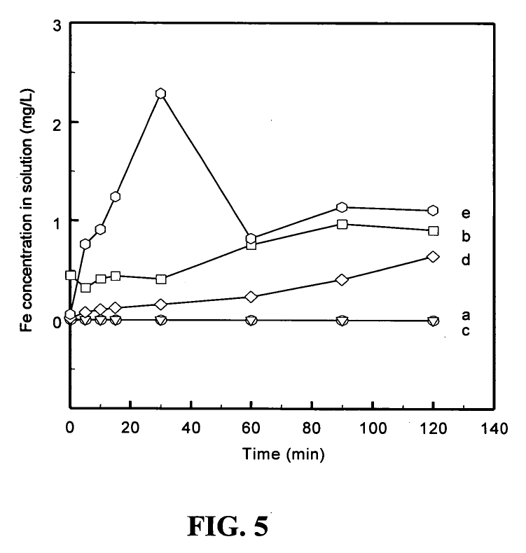

To address this issue, the Fe ion concentrations versus time under different conditions in solution were measured. With and without catalyst, the Fe ion concentration in reaction solution as a function of time was measured by Inductively Coupled Plasma (ICP) (Perkin Elmer Model: 3000 XL), and the results are presented in FIG. 5. Clearly, the reaction conditions can significantly influence Fe ion concentration in solution. Without any Fe—B catalyst (curves a and c), the Fe ion concentrations are near zero, as expected—because there is no Fe leaching. Without H₂O₂ and UVC light (dark), only with 1.0 g Fe—B/L (curve b), the Fe leaching is less than 1 mg/L. After 120 minutes reaction, indicating that Fe leaching from the Fe—B catalyst is not significant. Similar results were observed under conditions of 1.0 g Fe—B/L, 10 mM H₂O₂, and in the dark (see curve d). With 1×8 W UVC, 1.0 g Fe—B/L, and 10 mM H₂O₂ (curve e), the Fe ion concentration in solution increases initially from 0 to a peak value (about 2.2 mg/L) at about 30 minutes followed by a continuous decrease to a steady value (around 1.0 mg/L). The mechanism for this phenomenon is still unknown. Based on the results above, it can be deduced that the fast discoloration of 0.2 mM Orange II comes from three processes. The first is the adsorption of Orange II on the surface of Fe—B catalyst; the second is the oxidation of Orange II by heterogeneous photo-Fenton reaction; and the last is the oxidation of Orange II by homogeneous photo-Fenton reaction. However, it should be noted that near 90% removal of Orange II occurs in the first 10 minutes, and at that time Fe ion concentration is less than 1.0 mg/L. Therefore, the heterogeneous photo Fenton reaction appears to be mainly responsible for the fast discoloration of Orange II.

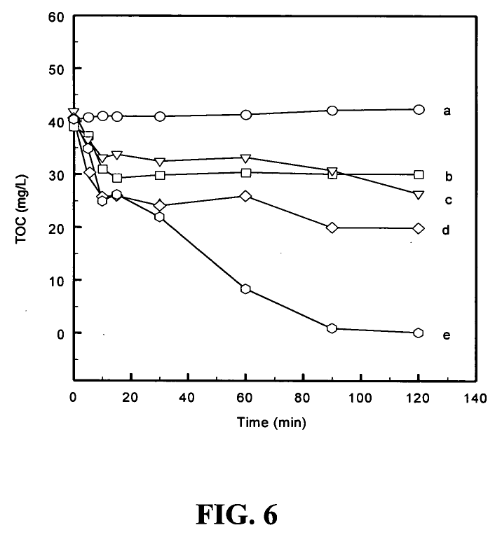

The TOC of 0.2 mM Orange II as a function of time under different conditions were measured and the results are illustrated in FIG. 6. Without H₂O₂ and Fe—B catalyst, only with 1×8 W UVC (curve a), the TOC of Orange II does not decrease at all indicating that direct photolysis of Orange II cannot cause any mineralization of Orange II. Without UVC light (dark) and 10 mM H₂O₂, but with 1.0 g Fe—B catalyst/L (curve b), the TOC decreases in the first 15 minutes, then, reaches a steady state value. As discussed earlier, this phenomenon is totally due to the adsorption of Orange II in solution on the surface of Fe—B catalyst. Without Fe—B catalyst, but with 10 mM H₂O₂, and with 1×8 W UVC (curve c), the TOC decreases rapidly in the first 10 minutes, then slowly continues to decrease. The limited slow mineralization is caused by the oxidation of Orange II due to the OH radicals coming from the direct photolysis of H₂O₂. However, it should be stressed that after 120 minutes, only around 30% of TOC was removed while more than 95% discoloration was achieved. This result implies that the OH radicals from the direct photolysis of H₂O₂ can only oxidize the Orange II into longer-lived colorless intermediates but cannot completely mineralize Orange II into H₂O and CO₂. Without UVC light (dark), but with 10 mM H₂O₂, and 1.0 g Fe—B/L (curve d), the TOC decreases in the first 10 minutes due to both adsorption of Orange II on the surface of Fe—B catalyst and oxidation of Orange II by Fenton reaction. From 10 to 15 minutes, the slight increase in TOC appears to stem from the absorption of Orange II on the surface of the Fe—B catalyst. The complex re-dissolves into the water; the original Orange II is not completely mineralized into H₂O and CO₂, but into some colorless intermediates. The further decrease in TOC is attributed to the Fenton reaction. As can be seen from curve d, after 120 minutes, only 50% TOC was removed, implying that Fenton instead of photo-Fenton reaction is not an effective technique for quick complete mineralization of Orange II. With 10 mM H₂O₂, 1.0 g Fe—B/L, and 1×8 W UVC (curve e), the TOC shows a quick decrease in the first 10 minutes, then a slightly increase followed by a continuous decrease to 100% removal. The decrease in the first 10 minutes is caused by both adsorption of Orange II on the surface of Fe—B catalyst and the oxidation of Orange II by OH radicals from heterogeneous photo-Fenton reaction. After that, the slight increase in TOC is again attributed to the fact that the Orange II adsorbed on the surface of Fe—B catalyst redissolve into solution due to the fast decrease in Orange II concentration as shown in FIG. 4 (curve e). The followed continuous decrease in TOC arises from oxidation of Orange II by OH radicals coming from the heterogeneous photo-Fenton reaction. After 120 minutes, the TOC almost reaches to zero. The result indicates that the presence of Fe—B catalyst can effectively mineralize Orange II into H₂O and CO₂.

### EXAMPLE 3

### Fe—B Nanocomposite As A Heterogeneous Photo Fenton Catalyst In the Discoloration And Mineralization of Azo Dye Orange II At Different Initial Solution PHs

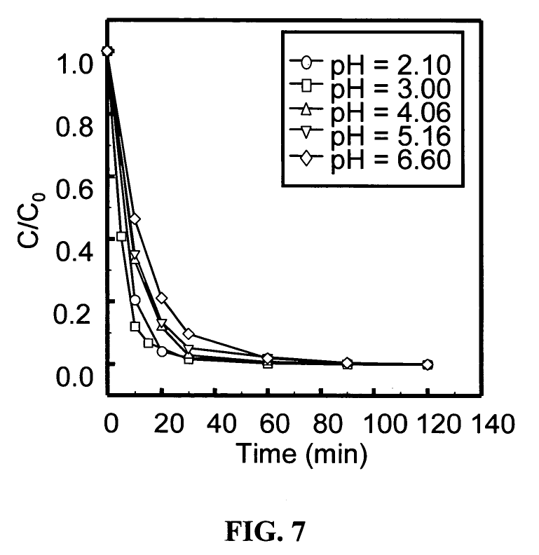

The effect of initial solution pH on the discoloration of 0.2 mM Orange II was first studied in the discoloration of 0.2 mM Orange II in the presence of 10 mM H₂O₂, 1.0 g/L Fe—B, and 1×8 W UVC light, and the result is shown in FIG. 7. Apparently, the initial solution pH can significantly influence the discoloration kinetics of 0.2 mM Orange II, indicating that initial solution pH can impose a great impact on the catalytic activity of Fe—B nanocomposite. The Fe—B nanocomposite exhibited the best catalytic activity at pH=3.00 while it showed a decreased catalytic activity when the initial solution pH departs from a pH of 3.00. However, it should be stressed that even at a pH of 6.60, which is very close to neutral, complete discoloration still could be achieved in less than 90 minutes, implying that the Fe—B catalyst still exhibited good photo catalytic activity at a high pH value. Significantly, the solution pH changes after 120 minutes reaction, and the extent of this change strongly depends on the initial solution pH. When the initial solution pHs are 2.10 and 3.00, the solution pH's after 120 minutes reaction increase slightly. When the initial solution pH is 4.06, the solution pH after 120 minutes slightly decreases. However, when the initial pHs are 5.16 and 6.60, the solution pHs after 120 minutes reaction decreases significantly.

To explain the change in solution pH, the complete mineralization of Orange II is described by the equation below:
C₁₆H₁₁N₂NaO₄S+42H₂O₂→16CO₂+46H₂O+2HNO₃+NaHSO₄ (3)

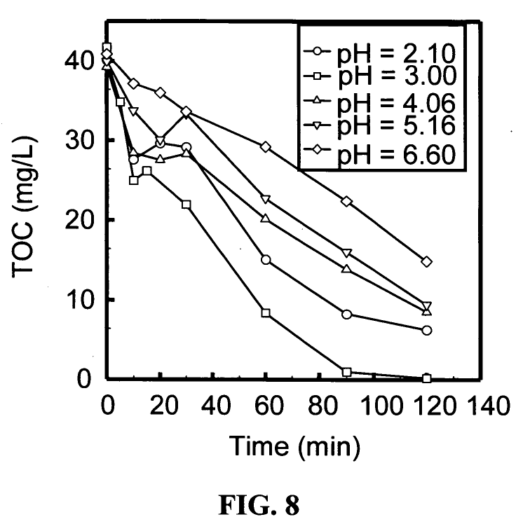

In addition to the discoloration, we are more interested in the mineralization of 0.2 mM Orange II in the presence of 10 mM H₂O₂, 1.0 g/L Fe—B, because even though complete discoloration of 0.2 mM Orange II could be achieved at less than 90 minutes as shown above, reaction intermediates may form, which might be more toxic than Orange II itself. Therefore, from the point view of a industrial wastewater treatment, complete mineralization or 100% TOC removal is more desirable than 100% discoloration, because only when 100% TOC removal is achieved, all organic intermediates in solution are mineralized into CO₂ and H₂O. FIG. 8 displays the effect of initial solution pH on the mineralization of 0.2 mM Orange II in the presence of 10 mM H₂O₂, 1.0 g/L Fe—B, and 1×8 W UVC light.

As can be seen from the figure, initial solution pH can markedly influence the mineralization of 0.2 mM Orange II. At initial solution pH=3.00, 100% TOC removal of 0.2 mM Orange II is achieved after 120 minutes reaction, indicating that the Fe—B nanocomposite exhibited the highest catalytic activity at this initial solution pH. However, as initial solution pH increases from 3.0 to 6.60, the mineralization kinetics become slower, indicating that the Fe—B nanocomposite showed a decreased photo catalytic activity. On the other hand, as the initial solution pH decreases from 3.00 to 2.10, the mineralization kinetics of 0.2 mM Orange II also becomes slow, implying that the Fe—B nanocomposite displays a decreased catalytic activity at pH=2.10. Notably, even when we started our reaction at a initial pH=4.06 to 6.60, the TOC removal of 0.2 mM Orange II still can reach 60 to 75%, indicating that the Fe—B nanocomposite exhibited reasonably good activity when initial solution pH is near neutral pH.

### EXAMPLE 4

### Fe—B Nanocomposite Film Coated On the Inner Wall Surface of A Batch Photo Reactor As A Heterogeneous Photo Fenton Catalyst In the Discoloration And Mineralization of Azo Dye Orange II

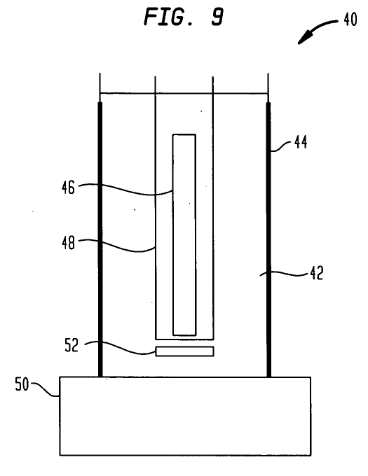

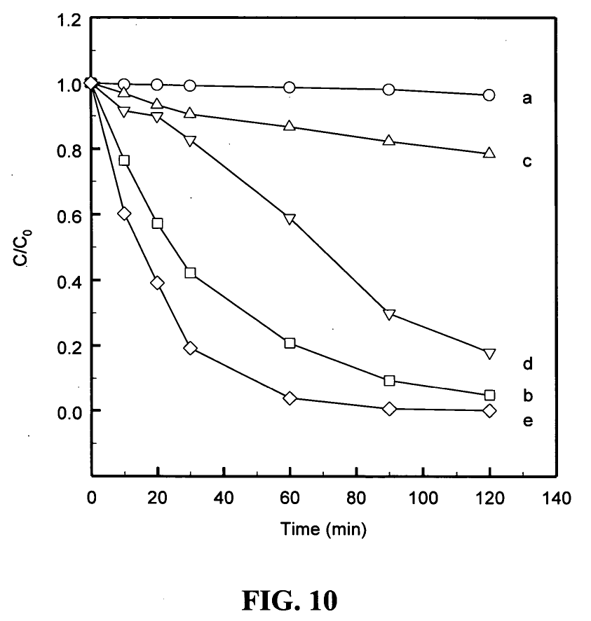

FIG. 9 shows a batch photo reactor 40, in which the discoloration of a 0.2 mM Orange II reaction solution 42 under different conditions was performed by using a Fe—B film catalyst coated on the inner wall surface 44 of the reactor 40 as a photo Fenton catalyst, and the results are shown in FIG. 10. Apparently, the discoloration kinetics of 0.2 mM Orange II are significantly influenced by experimental conditions. Without any H₂O₂ or catalyst, but with only 1×8 W UVC 46 inside a quartz tube 48 (curve a), color removal is less than 5% after 120 minutes, a negligible amount. This is so because Orange II itself can resist UVC light, and direct photolysis of Orange II is very limited. Without any catalyst but with 10 mM H₂O₂ and 1×8 W UVC, the color removal approached to 95% after 120 minutes, implying that the discoloration of 0.2 mM Orange II is significant. Here, Orange II was oxidized by the •OH radicals coming from direct photolysis of H₂O₂ in the presence of 8 W UVC as expressed by the following equation:
H₂O₂+UVC light→2•OH (4)

Without any UV light (dark), but with 10 mM H₂O₂ and the catalyst (curve c), the color removal of 0.2 mM Orange II was less than 20% after 120 minutes reaction, indicating that the discoloration of 0.2 mM Orange II is very slow. This is so because without any UV light, heterogeneous Fenton reaction itself is very slow, resulting in very limited OH radicals. Accordingly, a very slow discoloration of 0.2 mM Orange II occurred. With 1×8 W UVA, 10 mM H₂O₂, and the catalyst (curve d), the color removal of 0.2 mM Orange II was only about 80% after 120 minutes reaction, illustrating that the Fe—B film catalyst does not exhibit a good photo catalytic activity in the discoloration of 0.2 mM Orange II in the presence of 1×8 W UVA light and 10 mM H₂O₂. In another words, UVA does not appear to be suitable UV light source for the Fe—B film catalyst. With 1×8 W UVC, 10 mM H₂O₂, and the catalyst (curve e), 100% color removal of 0.2 mM Orange II can be achieved in less than 90 minutes, indicating that the Fe—B catalyst film shows a good photo catalytic activity in the discoloration of orange 11 in the presence of 1×8 W UVC light and 10 mM H₂O₂. This is so because the Fe—B film catalyst can act as a heterogeneous photo Fenton catalyst under irradiation of 1×8 W UVC, generating more •OH radicals that can attack Orange II. As a result, fast discoloration kinetics of 0.2 mM Orange II was observed. In this series of experiments, the reaction solution 42 was stirred vigorously using a magnetic stirrer 50 with a magnetic stirring bar 52 to maximize exposure to the Fe—B catalyst film or layer 44.

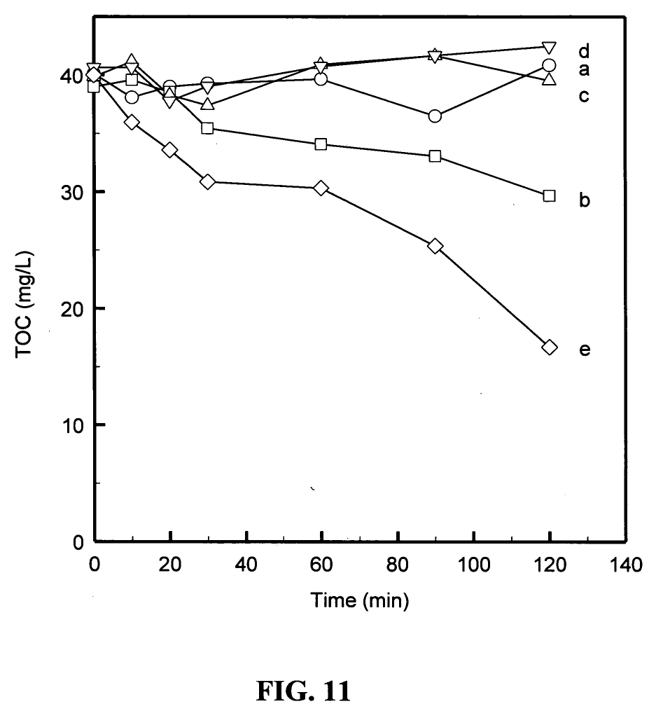

FIG. 11 depicts the TOC of 0.2 mM Orange II as a function of time under different conditions. As expected, the mineralization kinetics is significantly influenced by the experimental conditions. With only 1×8 W UVC, or the Fe—B film catalyst+10 mM H₂O₂+dark, or the Fe—B film catalyst+10 mM H₂O₂+8 W UVA, no significant mineralization of 0.2 mM Orange 11 was observed, implying that these experimental conditions are not effective at all in the mineralization of 0.2 mM Orange II.

With 10 mM H₂O₂+1×8 W UVC but no catalyst, the TOC removal of 0.2 mM Orange II was only about 25%, suggesting that mineralization of 0.2 mM Orange II caused by the attack of •OH radicals coming from direct photolysis of irradiation of 1×8 W UVC is not effective.

There are two possible reasons for this observation. The first is that direct photolysis of H₂O₂ generates a limited number of •OH radicals. The second is that the •OH radicals formed in solution are short-lived, and many of them decay before meeting Orange II molecules or reaction intermediates. Both reasons are responsible for the lower extent of mineralization of 0.2 mM Orange II. However, in the case of the Fe—B film catalyst +10 mM H₂O₂+8W UVC, more than 50-60% TOC removal of 0.2 mM Orange II was achieved after 120 minutes reaction, illustrating that the Fe—B film catalyst as a photo Fenton catalyst also exhibited reasonably good photo catalytic activity in the mineralization of 0.2 mM Orange II in the presence of 10 mM H₂O₂ and 1×8 W UVC. Because the •OH radicals formed on the surface of the Fe—B film catalyst can effectively attack the Orange II molecules or intermediates adsorbed on the surface of the Fe—B film catalyst, rapid mineralization of 0.2 mM Orange II occurs.

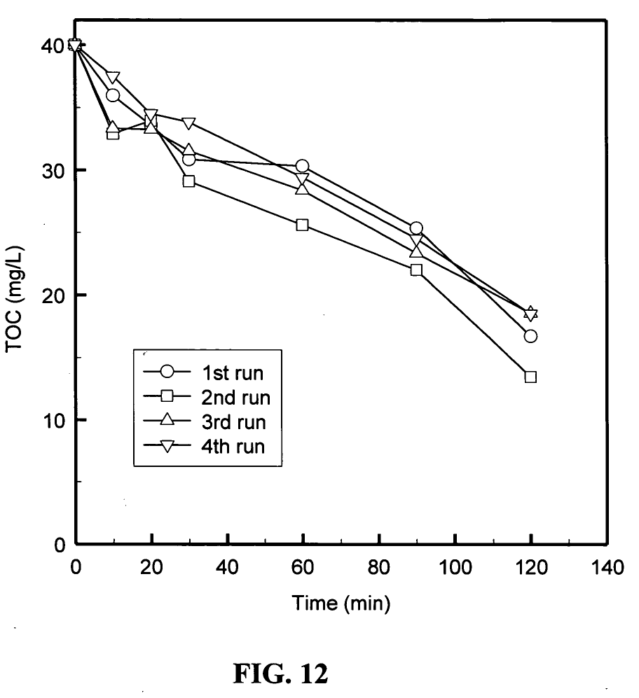

Another important property of a heterogeneous photo catalyst is its long-term stability. In order to test the long-term stability of the Fe—B film catalyst in the degradation of 0.2 mM Orange II in the presence of H₂O₂ and 1×8 W UVC, a repetitive reaction (up to the 4^{th} run) was performed. FIG. 12 shows the mineralization kinetics of 0.2 mM Orange II in the presence of H₂O₂ and 1×8 W UVC through repetitively run experiments. Compared with the first run, no significant deactivation of the Fe—B film catalyst was observed, suggesting that the Fe—B film catalyst could have long-term stability.

### EXAMPLE 5

### Fe—B Nanocomposite Film Coated On the Inner Wall Surface of A Falling Film Photo Reactor As A Heterogeneous Photo Fenton Catalyst In the Discoloration And Mineralization of Azo Dye Orange II

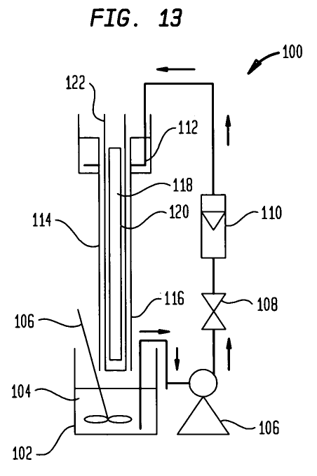

FIG. 13 shows the schematic diagram of a falling film photo reactor system 100, in which the Fe—B nanocomposite was coated as a layer or film on the inner wall surface as a heterogeneous photo Fenton catalyst for the oxidation of organic pollutants in the presence of UVC light and H₂O₂. The reactor system 100 includes a mix tank 102 for holding pollutant or contaminant containing solution 104, stirred by a mixer 106. Solution 104 is remixed from the mix tank 102 and pumped by pump 106 through valve 108, and flow meter 110 (if desired) to the liquid distributor 112. It collects adjacent the top of column 114 (preferably of stainless steel) which forms an elongated column 116 having the Fe—B 118 coating thereon. A UV lamp 120 is disposed centrally in a lamp sleeve 122 to irradiate the solution as it passes through the column 116 in contact with the Fe—B coating. Thus, the system treats contaminated solution with UV light 118 while it contacts the Fe—B catalyst, to break down the contaminants or pollutants (such as Azo dyes) contained therein. The initial amount of contaminants or pollutants can be measured, and subsequent measurements can be made to determine whether the contaminants have been decomposed to a desired degree. If so, the solution can be discharged, whereas it can otherwise be continually processed until it reaches the desired endpoint. Using electronic sensors, and a computer (not shown), it can be automatically controlled.

The references and patents listed below and throughout this application are incorporated by reference herein.

### REFERENCES CITED

Bossmann, S. H. et al., “Degradation of Polyvinyl Alcohol (PVA) by Homogeneous and Heterogeneous Photo Catalysis Applied to the Photochemically Enhanced Fenton Reactions,” Water Sci. Technol. 2001, 44 (5), 257-262.

Burch, R. ed., “Pillared Clays, Catalysis Today,” Elsevier: New York, 1998.

Feng, J. et al., “Degradation of Azo-dye Orange II by Photo-Assisted Fenton Reaction Using a Novel Composite of Iron Oxide and Silicate Nanoparticles as a Catalyst,” Ind. Eng. Chem. Res., 2003, 42 (10), 2058-2066.

Fernandez, J. et al., “Efficient Photo-Assisted Fenton Catalysis Mediated by Fe Ions on Nafion Membranes Active in the Abatement of Non-Biodegradable Azo-Dye,” Chem. Commun., 1998, 1493-1494

Fernandez, J. et al., “Photoassisted Fenton Degradation of Nonbiodegradable Azo Dye (Orange II) in Fe-free Solutions Mediated by Cation Transfer Membranes,” Langmuir, 1999, 15 (1), 185-192.

He, J. et al., “Heterogeneous Photo-Fenton Degradation of an Azo Dye in Aqueous H₂O₂/Iron Oxide Dispersions at Neutral pHs,” Chem. Lett., 2002, 86-87.

Gurol, et al. U.S. Pat. No. 5,755,977—“Continuous Catalytic Oxidation Process.”

Huling, et al. U.S. Pat. No. 6,663,781—“Contaminant Adsorption and Oxidation via the Fenton Reaction.”

Hu, X. et al., “Copper/MCM-41 as Catalyst for Photochemically Enhanced Oxidation of Phenol by Hydrogen Peroxide,” Catalysis Today, 2001, 68, 29-133.

McCauley, et al. U.S. Pat. No. 5,202,295 “Intercalated Clay Having Large Interlayer Spacing.”

McCauley, et al. U.S. Pat. No. 4,980,047 “Stable Intercalated Clays and Preparation Method.”

Mitchell, I V., ed., “Pillared Layered Structures, Current Trends and Applications,” Elsevier Applied Science, London, 1990.

Puma, G. L. and Yue, P. L., “Proceedings of the Sixth International Conference on Advanced Oxidation Technologies for Water and Air Remediation,” London, Ontario, Canada. 2000, Jun. 26-30. 105.

Wang, S. et al., “Preparation, Characterization, and Catalytic Properties of Clay-Based Nickel Catalysts for Methane Reforming,” Journal of Colloid and Interface Science, 1998, 204, 128-134.

Zhu, H. Y. et al., “Engineering the Structures of Nanoporous Clays with Micelles of Alkyl Polyether Surfactants,” Langmuir, 2001, 17, 588-594.

We claim:

1. A method for synthesizing bentonite clay-based Fe nanocomposite (Fe—B), using a pillaring technique, comprising the steps of:
(a) forming an aqueous bentonite suspension;
(b) forming an Fe³⁺ pillaring solution by adding NaCO₃ to an Fe(NO₃)₃ aqueous solution;
(c) adding the Fe³⁺ pillaring solution obtained in step (b) to the aqueous bentonite suspension obtained in step (a) with stirring to form bentonite Fe³⁺ pillaring solution mixture;
(d) aging the mixture at room temperature or 100° C. for 48 hours;
(e) separating by centrifugation and washing the mixture to obtain a catalyst precursor precipitate; and
(f) calcining the catalyst precursor to form intercalated bentonite iron oxide catalyst nanoparticles.

2. A process for treating wastewater comprising:
providing a reactor vessel containing Fe—B nanocomposite dispersed nanoparticles heterogeneous photo Fenton catalyst in accordance with claim 1;
introducing untreated wastewater into the reactor vessel; and
exposing the wastewater to H₂O₂ in the presence of UV light to oxidize contaminants in the wastewater.

3. A process according to claim 2, wherein the process is carried out at a pH of between about 2.8 through 3.2.

4. A process in accordance with claim 2, where the initial solution pH ranges from 2.8 through

5. A process according to claim 2, wherein the initial solution pH ranges from about 3.2 to 7.0.

6. A process according to claim 1, wherein the reactor vessel is stainless steel and the Fe—B nanoparticles are spray coated on the surface thereof by a hot spray method to form a layer thereon.

7. A process according to claim 6, wherein the stainless steel surface is sand blasted prior to spray coating.

8. A process according to the claim 6, wherein the Fe—B nanoparticles are coated on the inner wall surface of a batch photo reactor, and are used as a photo Fenton catalyst in the presence of UV light and H₂O₂ for wastewater treatment at an initial solution pH of between about 2.8 to 7.0.

9. A process according to claim 6, wherein the Fe—B nanocomposite film is coated on the inner wall surface of a cylindrical falling film photo reactor, and is used as a photo Fenton catalyst in the presence of UVC light and H₂O₂ for the wastewater treatment at an initial solution pH of between about 2.8 and about 7.0.

10. A reactor for treatment of wastewater, comprising:
a stainless steel vessel having Fe—B nanoparticles in accordance with claim 1 sprayed to form a layer thereof on an inner surface;
a UV light source to irradiate wastewater in the reactor; a hydrogen peroxide source for adding hydrogen peroxide to wastewater in the reactor;
means for introducing wastewater in the reactor for treatment; and
means for removing wastewater from the reactor after treatment.

11. A reactor in accordance with claim 10, wherein the stainless steel vessel is an elongated column with a UV light source disposed therein.

12. A reactor in accordance with claim 10, wherein the UV light source is a UVC light source.

13. A reactor in accordance with claim 11, wherein the UV light source is a UVC light source.
